(19) United States
(12) Patent Application Publication
(10) Pub. No.: US 2005/0219994 A1
(43) Pub. Date: Oct. 6, 2005

(54) Optical recording medium

(75) Inventors: Narutoshi Fukuzawa, Tokyo (JP); Takashi Kikukawa, Tokyo (JP); Tatsuhiro Kobayashi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK CORPORATION, Tokyo (JP)

(21) Appl. No.: 11/090,485

(22) Filed: Mar. 28, 2005

(30) Foreign Application Priority Data
Mar. 29, 2004 (JP) 2004-096362

(51) Int. Cl. G11B 7/24

(52) U.S. Cl. 369/275.2; 428/64.4

(57) ABSTRACT

An optical recording medium for recording data by irradiating a laser beam and forming a recording mark row containing at least one of recording marks and blank areas smaller than a resolution limit and reproducing the recorded data, comprising a layered body having a recording layer, a light absorbing layer, and a dielectric layer at intermediary of the recording layer and the light absorbing layer, wherein the light absorbing layer is crystalline when film formation is completed, and has a property to maintain the crystalline even when the laser beam is irradiated.

### BACKGROUND OF THE INVENTION

The present invention relates to an optical recording medium and, more specifically, to an optical recording medium which can stably reproduce data recorded by a recording mark row including at least one of recording marks and blank areas smaller than the resolution limit a plurality of numbers of times.

Hitherto, as a recording medium for recording digital data, an optical recording medium represented by a CD or a DVD is widely utilized. However, in recent years, development is toward to an optical recording medium having a larger capacity and a high data transmission rate.

In such the optical recording medium, increasing of recording capacity of the optical recording medium is achieved by decreasing a wavelength λ of a laser beam used for recording and reproducing data and increasing in a numerical aperture NA of an objective lens to condense a beam spot diameter of the laser beam.

In the optical recording medium, when the lengths of the recording marks recorded in the optical recoding medium and the length between the adjacent recording marks, that is, the area where no recording mark is formed (hereinafter, referred to as “blank areas”) is lowered to a value smaller than the resolution limit, reproduction of data from the optical recording medium is disabled.

The resolution limit is determined by the wavelength λ of the laser beam and the numerical aperture NA of the objective lens for focusing the laser beam, and when the frequency of repetition between the recording mark and the blank area, that is, the spatial frequency is equal to or larger than 2NA/λ (which is diffraction limit), reading of data recorded in the frequency of repetition between the recording mark and the blank area is disabled.

Therefore, the lengths of the recording marks and the blanks corresponding to at least λ/4NA (which is resolution limit) respectively, and when focusing the laser beam with the wavelength of λ on the optical recording medium by the objective lens having the numerical aperture NA, the recording marks and the blank areas of λ/4NA in length are the shortest recording mark and the blank areas which can be read.

When reproducing data in this manner, there exists a resolution limit in which data generation is possible, and there is a limit in length of the recording marks and of the blank areas which can be reproduced. Therefore, even though the recording marks and the blank areas of a length smaller than the resolution limit are formed and data is recorded therein, the recorded data cannot be reproduced. Therefore, the lengths of the recording marks and the lengths of the blank areas, which can be formed on the optical recording medium when recording data, are inevitably limited.

Therefore, in order to increase the recording capacity of the optical recording medium, it is required to lower the resolution limit by reducing the wavelength λ of a laser beam used for reproducing data or increasing the numerical aperture NA of the objective lens, so that data including the shorter recording mark row can be reproduced.

However, there was a limit in reducing the wavelength λ of the laser beam used for reproducing of data or in increasing the numerical aperture NA of the objective lens, and hence there was a limit in increasing the recording capacity of the optical recording medium by lowering the resolution limit.

In view of such circumstances, various techniques for forming the recording mark row smaller than the resolution limit and reproducing recorded data have been proposed. As one of such technologies, for example, a technology to substantially increase the numerical aperture NA in the optical recording medium by providing a layer for masking the laser beam in the optical recording medium is proposed.

As a different technology from those shown above, there is also proposed a technology to reproduce data recorded by the recording mark row smaller than the resolution limit by utilizing near-field light (for example, see Non-Patent Document 1).

The optical recording medium described in the above-described document includes a dielectric layer containing a mixture of ZnS and SiO₂ as a main component, a recording layer containing platinum oxide as a main component, a dielectric layer containing a mixture of ZnS and SiO₂ as a main component, a light absorbing layer containing Ag_{6.0}In4.5Sb60.8Te28.7 which is a phase change material as a main component, and a dielectric layer containing a mixture of ZnS and SiO₂ as a main component laminated in sequence as described above on the surface of a polycarbonate substrate from the side of the incident surface of the laser beam.

In the optical recording medium, a laser beam is irradiated to decompose platinum oxide into platinum and oxygen, thereby generating oxygen gas to form a void in the recording layer and, simultaneously, the dielectric layer and the light absorbing layer adjacent to the recording layer are deformed to form the recording mark row smaller lower than the resolution limit to record data.

Actually, in the optical recording medium as described above, it was necessary to irradiate a laser beam having a reproducing power higher than the normal optical recording medium. However, reproducing of data recorded by a recording mark row of 200 nm, which is smaller than 265 mm as the resolution limit, was successful using a laser beam of 635 nm in wavelength and an objective lens of 0.60 in numerical aperture NA.

[Non-Patent Document 1] Takashi Kikukawa, and three others. “Rigid bubble pit formation and huge signal enhancement in super-resolution near-field structure disk with platinum-oxide layer” APPLIED PHYSICS LETTERS, American Institute of Physics, Dec. 16th, 2002, Volume number 81, No. 25, p. 4697-4699.

As described above, in the optical recording medium in Non-Patent Document 1, data composed of the recording mark row including the recording marks and the blank areas can be reproduced even when the lengths of the recording marks or the lengths of the blank areas between the adjacent recording marks are smaller than the resolution limit.

However, on the other hand, there is a problem in the optical recording medium described above such that, when data recorded in the optical recording medium is reproduced a plurality of numbers of times as shown in FIG. 11, the noise level starts to increase when the number of times of reproducing exceeds about 60 times and continues to increase until the number of times of reproducing exceeds about 200 times. Since the noise level which is increased in this manner cannot be reduced to its original level until a laser beam is irradiated on the identical track by more than about 400 times as shown in FIG. 11, it is difficult to reproduce data recorded in the optical recording medium stably a plurality of numbers of times.

### SUMMARY OF THE INVENTION

Accordingly, it is an object of the present invention to provide an optical recording medium which can stably reproduce data recorded by a recording mark row including at least one of recording marks and blank areas smaller than the resolution limit a plurality of numbers of times.

According to the present invention, an optical recording medium on which a recording mark row containing at least one of recording marks and blank areas smaller than a resolution limit is formed to record data and from which the recorded data are reproduced, by irradiating a laser beam, the optical recording medium comprises a layered body including a recording layer, a light absorbing layer, and a dielectric layer at intermediary of the recording layer and the light absorbing layer, in that the light absorbing layer is crystalline when film formation is completed, and has a property to maintain the crystalline even when the laser beam is irradiated.

### BRIEF DESCRIPTION OF THE DRAWINGS

FIG. 1 is a schematic cross-sectional view of an optical recording medium according to a preferred embodiment of the present invention;

FIG. 2 is a schematic enlarged cross-sectional view of a portion indicated by A in FIG. 1;

FIG. 3(a) is a partly enlarged schematic cross-sectional view of the optical recording medium before data is recorded therein, and

FIG. 3(b) is a partly enlarged schematic cross-sectional view of the optical recording medium after data is recorded.

FIG. 4 is a schematic cross-sectional view of the optical recording medium according to another preferred embodiment of the present invention.

FIG. 5(a) is a partly enlarged schematic cross-sectional view of the optical recording medium before data is recorded therein, and

FIG. 5(b) is a partly enlarged schematic cross-sectional view of the optical recording medium after data is recorded.

FIG. 6 is a schematic cross sectional view of the optical recording medium according to another preferred embodiment of the present invention.

FIG. 7(a) is a partly enlarged schematic cross-sectional view of the optical recording medium before data is recorded therein, and

FIG. 7(b) is a partly enlarged schematic cross-sectional view of the optical recording medium after data is recorded.

FIG. 8 is a graph showing relations between the C/N ratios of the reproduced signals and the number of times of reproducing.

FIG. 9 is a graph showing the relation between the C/N ratios of the reproduced signals and a reproducing power Pr of a laser beam.

FIG. 10 is a graph showing relations between the C/N ratios of the reproduced signal and the reproducing power Pr of the laser beam.

FIG. 11 is a graph showing relations between the noise of the reproduced signals and the number of times of reproducing.

### DETAILED DESCRIPTION OF THE PREFERRED EMBODIMENTS

After having devoted themselves to study to achieve the above-described object, the Inventors found that increase in noise level when the recorded data is reproduced a plurality of numbers of times in the optical recording medium in the related art is caused by the fact that when a laser beam which has high reproducing power is irradiated, a light absorbing layer is heated and hence is subjected to a phase change, and since the speed of the phase change is not uniform in the plane of the light absorbing layer, there exist areas of amorphous material and areas of crystalline material irregularly on the light absorbing layer until the phase change has completed over the entire light absorbing layer, whereby the optical characteristics of the optical recording medium is adversely affected.

Such a problem can be improved by performing initialization for crystallizing the entire light absorbing layer in a stage of manufacturing the optical recording medium. However, in order to initialize the light absorbing layer, it is necessary to add a process therefor, which results in increase in cost. Granted that the initialization is performed, when the temperature of the light absorbing layer reaches a fusing point when the laser beam is irradiated and hence amorphous material is formed, the phase of the light absorbing layer is changed. Therefore, it cannot solve the problem completely.

Based on such knowledge, the above-described object of the present invention is achieved by an optical recording medium for recording data by irradiating a laser beam and forming a recording mark row containing at least one of recording marks and blank areas smaller than the resolution limit and reproducing the recorded data, including a layered body having a recording layer and a light absorbing layer with the intermediary of at least a dielectric layer, characterized in that the light absorbing layer is crystalline material when film formation is completed, and has a property to maintain the crystalline material even when the laser beam is irradiated.

In this specification, the term “to maintain crystalline material even when a laser beam is irradiated” means that even when the laser beam is irradiated and part of the light absorbing layer is fused, an area of amorphous material is not formed in the light absorbing layer, the crystalline state is maintained, and unintended phase change does not occur.

In the present invention, since the light absorbing layer is crystalline material when film formation is completed, and has a property to maintain the crystalline material even when the laser beam is irradiated and, according to the present invention, the phase of the light absorbing layer does not change even when a laser beam of high reproducing power is irradiated and the light absorbing layer is heated, the reflecting level with respect to the laser beam can always be stabilized irrespective of the number of times of reproducing. Therefore, the data recorded in the optical recording medium can be reproduced stably a plurality of numbers of times.

In the present invention, preferably, the light absorbing layer includes a mixture containing Sb as a main component, and is crystalline material.

According to the study of the Inventors, it is found that when the light absorbing layer is formed to include the mixture containing Sb as a main component and to be crystalline material, even when the data recorded in the optical recording medium is reproduced a plurality of numbers of times, the reflection level with respect to the laser beam can be stabilized, and the recorded data can be reproduced with sufficiently high C/N (carrier to noise) ratio.

Therefore, according to the present invention, the data recorded by the recording mark row containing at least one of the recording marks and the blank areas smaller than the resolution limit can be reproduced as desired a plurality of numbers of times.

In the present invention, more preferably, the light absorbing layer contains Sb and Sn, or Sb and Bi as main components. In the present invention, “the light absorbing layer contains Sb and Sn, or Sb and Bi as main components” means that the sum of the content of Sb and the content of Sn, or the sum of the content of Sb and the content of Bi is at least 60 atomic %.

In the present invention, when the light absorbing layer contains Sb and Sn as main components, the light absorbing layer contains preferably 9 atom percent to 90 atomic % of Sn, and more preferably, 35 atomic % to 85 atomic % of Sn.

When the light absorbing layer contains 9 atomic % to 90 atomic % of Sn, a reproduced signal of sufficiently high C/N ratio can be obtained even when the lengths of the recording marks or the lengths of the blank areas between the adjacent recording marks are smaller than the resolution limit, and when 35 atomic % to 85 atomic % of Sn is contained, the reproduced signal of higher C/N ratio can be obtained.

In the present invention, when the light absorbing layer contains the Sb and Bi as main components, the light absorbing layer contains preferably 25 atomic % to 65 atomic % of Bi, and more preferably, contains 40 atomic % to 50 atomic % of Bi.

When the light absorbing layer contains 25 atomic % to 65 atomic % of Bi, even when the lengths of the recording marks or the lengths of the blank areas between the adjacent recording marks are smaller than the resolution limit, the reproduced signal with sufficiently high C/N ratio can be obtained, and when it contains 40 atomic % to 50 atomic % of Bi, the reproduced signal of higher C/N ratio can be obtained.

In the present invention, preferably the light absorbing layer has a thickness from 5 nm to 100 nm. When the thickness of the light absorbing layer is smaller than 5 nm, the ratio of light absorption is too low, and when the thickness of the light absorbing layer exceeds 100 nm, the light absorbing layer is deformed when the volume of the recording layer changes as will be described later, which is not preferable.

In the present invention, the recording layer is preferably configured in such a manner that when a laser beam set to a recording power is irradiated, the volume change occurs in the area where the laser beam is irradiated. Since the area where the volume change of the recording layer occurred has different optical characteristics from the area where no volume change is occurred, it can be used as the recording marks.

The recording layer may be formed of noble metal oxide, noble metal nitride, organic dye or thin metal or semimetal film having a low coefficient of thermal conductivity.

In the present invention, when the recording layer is formed of noble metal oxide, preferably, platinum oxide is used as the noble metal oxide for forming the recording layer.

The decomposition temperature of platinum oxide is higher than those of other noble metal oxide, and hence even though heat is diffused from the area where the laser beam is irradiated to the peripheral area when forming the recording marks by irradiating the laser beam set to the recording power, the platinum oxide is prevented from generating a decomposition reaction in the area other than the area where the laser beam is irradiated, and hence the volume of the desired area of the recording layer can be changed to form the recording marks.

When the data is reproduced by irradiating the laser beam of high reproducing power, since the decomposition temperature of platinum oxide is higher than those of other noble metal oxide, platinum oxide is prevented from being decomposed into platinum and oxygen, and hence even though the data recorded in the optical recording medium is repeatedly reproduced, the shapes of the recording marks do not change, and the additional volume change does not occur in the area other than the area where the recording marks are formed. Therefore, durability of the optical recording medium against reproducing can be improved.

In the present invention, when the recording layer is formed of noble metal nitride, platinum nitride is preferably used as the noble metal nitride for forming the recording layer.

In the present invention, when the recording layer is formed of organic dye, the organic dye having absorbency with respect to the wavelength of the recording laser beam and a decomposition temperature of 300° C. or higher is preferably used as an organic dye for forming the recording layer. For example, in the case of recording the data on the optical recording medium by irradiating a laser beam having a wavelength from 390 to 420 nm, macrocyclic dyes such as phthalocyanine derivative, azaporphyrin derivative, porphycene derivative, corrole derivative or dyes such as coumarin derivative, metal-containing azaoxonol derivative, benzotriazole derivative, styryl derivative, hexatrien derivative can be used. Among these dyes, for example, mono-methine cyanine or porphyrin is preferable from the viewpoints of cost of the material itself, film-forming property, or absorbance with respect to the wavelength of the laser beam. The macrocyclic dyes such as porphyrin, in which pyrrole rings are connected, have a larger possibility to be improved in radiation proofing property by a central metal or by a modifying functional group.

When the recording layer contains the organic dye as a main component, a mixture mixed with a plurality of dyes may be contained as a main component for optical adjustment, and element other than dye can be added for the purpose of achieving storage stability against high-temperature and high-humidity, radiation proofing property, promotion of decomposition, prevention of agglutination.

In the present invention, when the recording layer contains metal or semimetal having low coefficient of thermal conductivity as a main component, the metal or semimetal contained in the recording layer as a main component is preferably the metal or semimetal having the coefficient of thermal conductivity of 2.0 W/(cm·K) or below, and more specifically, the recording layer is formed of at least one kind of metal or semimetal selected from a group including Sn, Zn, Mg, Bi, Ti and Si or an allow including these metals or semimetals. When the recording layer is formed of these metal or semimetals, the area where the laser beam set to the recording power is efficiently heated, and hence the small recording marks smaller than the resolution limit can be efficiently formed.

In the present invention, preferably, a reflecting layer is formed on the substrate.

In the case in which the reflecting layer is formed on the substrate, when a laser beam set to a reproducing power Pr is irradiated thereon, heat provided by the laser beam can be diffused to the periphery from the position where the laser beam is irradiated by the reflecting layer. Therefore, excessive heating of the optical recording medium can be prevented reliably, and the data recorded in the optical recording medium can be prevented from deteriorating.

When the reflecting layer is formed on the substrate, a laser beam reflected from the surface of the reflecting layer and a laser beam reflected from the layer laminated on the reflecting layer interfere with each other, and consequently, the amount of light of the reflected light which constitutes the reproduced signal increases, whereby the C/N ratio of the reproduced signal can be improved.

In the present invention, preferably, the dielectric layer and the light absorbing layer are configured so as to be deformed in accordance with the volume change of the recording layer when the recording mark row is formed on the recording layer.

Since the area where the dielectric layer and the light absorbing layer are deformed has different optical characteristics from the area where the dielectric layer and the light absorbing layer are not deformed, the reproduced signal having better signal characteristics can be obtained.

In the present invention, preferably, the dielectric layer contains a mixture of ZnS and SiO₂ as a main component. The dielectric layer containing the mixture of ZnS an SiO₂ as a main component has high optical transmittance with respect to the laser beam for recording and reproducing, and relatively low hardness, whereby the dielectric layer can easily be deformed when the volume of the recording layer changes.

According to the present invention, an optical recording medium which can stably reproducedata recorded by a recording mark row including at least one of recording marks and blank areas smaller than the resolution limit a plurality of numbers of times can be provided.

Referring now to the attached drawings, preferred embodiments of the present invention will be described in detail.

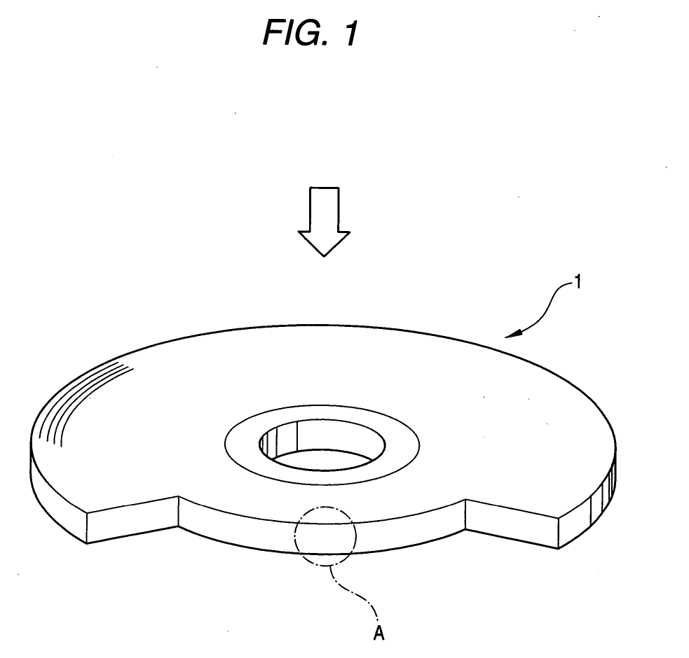

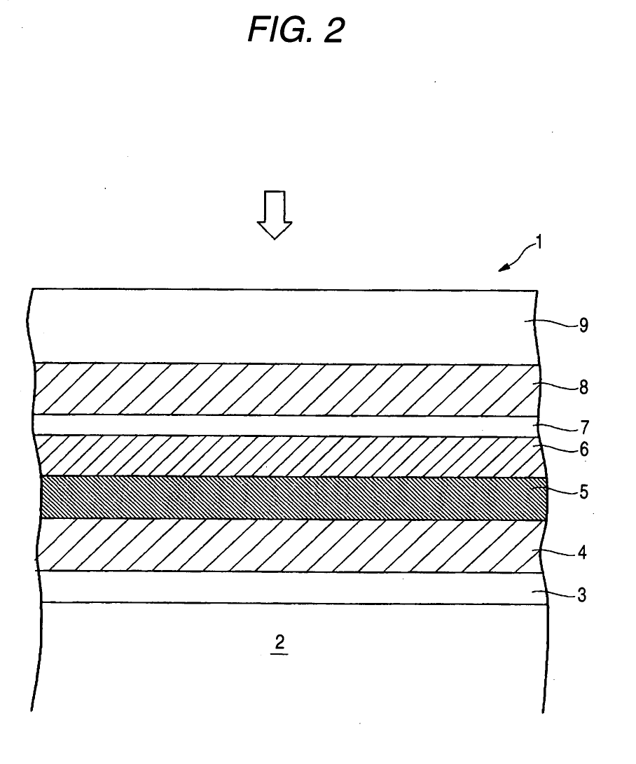

FIG. 1 is a schematic perspective view of an optical recording medium according to the preferred embodiment of the present invention. FIG. 2 is a schematic enlarged cross-sectional view of a portion indicated by A in the cross-section taken along the track of the optical recording medium shown in FIG. 1.

As shown in FIG. 2, an optical recording medium 1 according to the present embodiment includes a supporting substrate 2, and a reflecting layer 3, a third dielectric layer 4, a light absorbing layer 5, a second dielectric layer 6, a recording layer 7, a first dielectric layer 8, a light-transmitting layer 9 are laminated on the supporting substrate 2 in this order.

In the present embodiment, as shown in FIG. 2, the optical recording medium 1 is configured in such a manner that a laser beam is irradiated from the side of the light-transmitting layer 9 to record data, and the recorded data is reproduced. The laser beam has a wavelength λ from 390 nm to 420 nm, and is focused on the optical recording medium 1 by an objective lens having a numerical aperture of 0.7 to 0.9 NA.

The supporting substrate 2 functions as a supporting member for securable a mechanical strength required for the optical recording medium 1.

The supporting substrate 2 has a groove (not shown) and a land (not shown) spirally formed thereon from the position near the center toward the outer edge thereof.

The groove and the land function as a guide track for the laser beam in the case of recording data on the recording layer 7 or reproducing the data recorded in the recording layer 7.

The material for forming the supporting substrate 2 is not specifically limited as long as it functions as a supporting member of the optical recording medium 1, and the supporting substrate 2 may be formed of, for example, glass, ceramics, or resin. From the ease of formation, resin is preferably used out of these materials. Such a resin includes polycarbonate resin, olefin resin, acryl resin, epoxy resin, polystyrene resin, polyethylene resin, polypropylene resin, silicone resin, fluorinated rein, ABS resin, urethane resin. Among these resins, polycarbonate resin and olefin resin are specifically preferred in view of forming characteristics and optical characteristics.

Although the thickness of the supporting substrate 2 is not specifically limited, the supporting substrate 2 is preferably formed to have 1.0 mm to 1.2 mm, and more preferably, about 1.1 mm in thickness in view of compatibility with the current optical recording medium.

As shown in FIG. 2, the supporting substrate 2 is formed on its surface with the reflecting layer 3.

The reflecting layer 3 plays a role to reflect the laser beam incident through the light-transmitting layer 9 and emit the laser beam again through the light-transmitting layer 9.

The material for forming the reflecting layer 3 is not specifically limited as long as it can reflect the laser beam, and the reflecting layer 3 can be formed using at least one material selected from a group of Au, Ag, Cu, Pt, Al, Ti, Cr, Fe, Co, Ni, Mg, Zn, Ge, and Si.

The thickness of the reflecting layer 3 is not specifically limited, but the reflecting layer 3 is preferably formed to have a thickness from 5 nm to 200 nm.

As shown in FIG. 2, the reflecting layer 3 is formed on its surface with the third dielectric layer 4.

In the present embodiment, the third dielectric layer 4 has a function to protect the supporting substrate 2 and the reflecting layer 3 and to physically and chemically protect the light absorbing layer 5 formed thereon.

The dielectric material for forming the third dielectric layer 4 is not specifically limited, and for example, the third dielectric layer 4 can be formed of the dielectric material containing oxide, nitride, sulfide, fluoride, or the combination thereof as a main component, and the third dielectric layer 4 is preferably formed of oxide, nitride, sulfide, or fluoride containing at least one type of metal selected from a group including Si, Zn, Al, Ta, Ti, Co, Zr, Pb, Ag, Sn, Ca, Ce, V, Cu, Fe and Mg, or the compound thereof. The dielectric material for forming the third dielectric layer 4 is specifically preferably a compound of ZnS and SiO₂, and more preferably, the mol ratio of ZnS and SiO₂ is 80:20.

The third dielectric layer 4 can be formed on the surface of the reflecting layer 3 by a vapor-phase growth using, for example, the chemical species containing the elements constituting the third dielectric layer 4. The vapor-phase growth includes a vacuum depositing method and a sputtering method.

Although the thickness of the third dielectric layer 4 is not specifically limited, a thickness from 10 nm to 140 nm is preferable.

As shown in FIG. 2, the third dielectric layer 4 is formed on its surface with the light absorbing layer 5.

In present embodiment, the light absorbing layer 5 has a function to absorb a laser beam when the laser beam set to a recording power Pw is irradiated to the optical recording medium 1, generate heat, and transmit the generated heat to the recording layer 7 described later.

In the present embodiment, the light absorbing layer 5 contains Sb and Sn or Sb and Bi as main components. In this specification, “to contain Sb and Sn or Sb and Bi as main components” means that the sum of the content of Sb and the content of Sn, or the sum of the content of Sb and the content of Bi is at least 60 atomic %.

Since the light absorbing layer 5 according to the present embodiment is formed into a film in the state of crystalline material, and a mixture of Sb and Sn or a mixture of Sb and Bi contained in the light absorbing layer 5 has no phase change characteristic, even though the laser beam set to the recording power Pw or a reproducing power Pr is irradiated and part of the light absorbing layer 5 is fused, the area of amorphous material is not formed on the light absorbing layer 5, and hence the state of the crystalline material is maintained.

In the present embodiment, in the case in which the light absorbing layer 5 contains Sb and Sn as main components, the light absorbing layer 5 preferably contains 9 atomic % to 90 atomic % of Sn, and more preferably, contains 35 atomic % to 85 atomic % of Sn.

When the light absorbing layer 5 includes 9 atomic % to 90 atomic % of Sn, even though the lengths of the recording marks or the lengths of the blank areas between the adjacent recording marks are smaller than the resolution limit, a reproduced signal of a sufficiently high C/N ratio can be obtained. On the other hand, when 35 atomic % to 85 atomic % of Sn is contained, the reproduced signal of a higher C/N ratio can be obtained.

In the present embodiment, the light absorbing layer 5 contains Sb and Bi as main components, the light absorbing layer 5 preferably contains from 25 atomic % to 65 atomic % of Bl, and more preferably, from 40 atomic % to 50 atomic % of Bi.

In the case in which the light absorbing layer 5 contains from 25 atomic % to 65 atomic % of Bi, even when the lengths of the recording marks or the lengths of the blank areas between the adjacent recording marks are smaller than the resolution limit, a reproduced signal of sufficiently high C/N ratio can be obtained. In the case in which the light absorbing layer 5 contains from 40 atomic % to 50 atomic % of Bi, the reproduced signal of higher C/N ratio can be obtained.

The light absorbing layer 5 can be formed on the surface of the third dielectric layer 4 by a vapor-phase growth using the chemical species containing the elements constituting the light absorbing layer 5, and the vapor-phase growth includes a vacuum depositing method and a sputtering method.

The light absorbing layer 5 preferably has a thickness from 5 nm to 100 nm. When the thickness of the light absorbing layer 5 is smaller than 5 nm, the coefficient of light absorption is too low, and in contrast, when the thickness of the light absorbing layer 5 exceeds 100 nm, when a void is formed on the recording layer 7, the light absorbing layer 5 can hardly be deformed as described later, which is not preferable.

As shown in FIG. 2, the light absorbing layer 5 is formed on its surface with the second dielectric layer 6.

In the present embodiment, the second dielectric layer 6 has a function for physically and chemically protecting the recording layer 7, described later, together with the first dielectric layer 8, described later.

In the present embodiment, the second dielectric layer 6 contains a mixture of ZnS and SiO₂ as a main component. Since the dielectric layer containing the mixture of ZnS and SiO₂ as a main component has a high optical transmittance with respect to a laser beam having the wavelength λ from 390 nm to 420 nm, and the hardness is relatively low, the second dielectric layer 6 can easily be deformed when a void is formed in the recording layer 7, which is preferable.

The second dielectric layer 6 can be formed by the vapor-phase growth such as the vacuum depositing method and the sputtering method.

The second dielectric layer 6 is preferably formed to have a thickness from 5 nm to 100 nm.

As shown in FIG. 2, the recording layer 7 is formed on the surface of the second dielectric layer 6.

In the present embodiment, the recording layer 7 is a layer on which the data is recorded, and when the data is recorded, the recording marks are formed on the recording layer 7.

In the present embodiment, the recording layer 7 includes platinum oxide PtOx as a main component.

In the present embodiment, in order to obtain a reproduced signal having a high C/N ratio even though the lengths of the recording marks or the lengths of the blank areas between the adjacent recording marks are smaller than the resolution limit, the relation: 1.0≦x<3.0 is preferable.

The recording layer 7 can be formed on the surface of the second dielectric layer 6 by the vapor-phase growth using the chemical species including the elements contained in the recording layer 7 as main components, and the vapor-phase growth includes the vacuum depositing method or the sputtering method.

When the thickness of the recording layer 7 is too small, there is a case in which the recording layer 7 cannot be formed as a continuous film, and in contrast, when the thickness of the recording layer 7 is too large, the recording layer 7 can hardly be deformed. In view of such points, the recording layer 7 preferably has a thickness from 2 nm to 20 nm, and more preferably a thickness from 4 nm to 20 nm.

As shown in FIG. 2, the first dielectric layer 8 is formed on the surface of the recording layer 7.

In the present embodiment, the first dielectric layer 8 has a function to physically and chemically protect the recording layer 7.

The first dielectric layer 8 can be formed by the same material as the third dielectric layer 4, and can be formed, for example, by the vapor-phase growth such as the vacuum depositing method or the sputtering method as in the case of the third dielectric layer 4.

As shown in FIG. 2, the first dielectric layer 8 is formed on its surface with the light-transmitting layer 9.

The light-transmitting layer 9 is a layer through which the laser beam can pass, and the surface thereof constitutes a laser beam incident surface.

The material for forming the light-transmitting layer 9 is not specifically limited as long as it is a material which is optically transparent, low in optical absorption and reflection in the range from 390 nm to 420 nm, which is the wavelength range of the laser beam to be used, and low in birefringence. When the light-transmitting layer 9 is formed by spin coating method or the like, a UV-curable resin, an electron radiation curable resin, or heat curable resin are used for forming the light-transmitting layer 9, and more preferably, active energy beam curable resin such as the UV-curable resin or the electron radiation curable resin is used for forming the light-transmitting layer 9.

The light-transmitting layer 9 may be formed on the surface of the first dielectric layer 8 by adhering a sheet formed of a light-transmitting resin using adhesive agent.

The thickness of the light-transmitting layer 9 is preferably from 10 μm to 200 μm when forming the light-transmitting layer 9 by the spin coating method, and is preferably from 50 μm to 150 μm when forming the light-transmitting layer 9 by adhering the sheet formed of the light-transmitting resin to the surface of the first dielectric layer 8 using adhesive agent.

Data is recorded in and reproduced from the optical recording medium 1 configured as described above in the following manner.

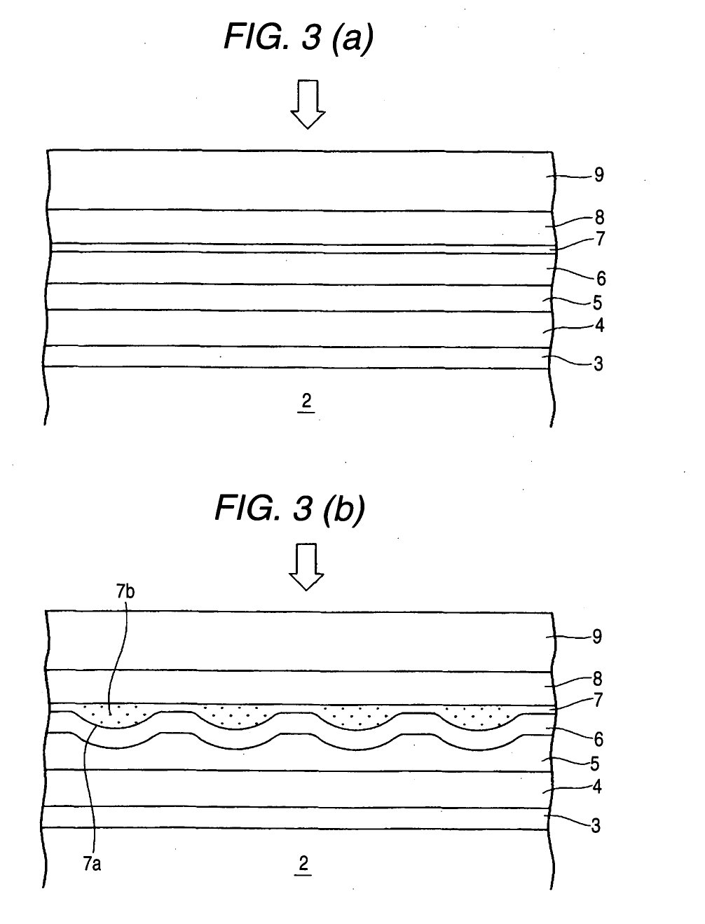

FIG. 3(a) is a partly enlarged schematic cross-sectional view of the optical recording medium 1 before data is recorded therein, and FIG. 3(b) is a partly enlarged schematic cross-sectional view of the optical recording medium 1 after data is recorded.

When recording data in the optical recording medium 1, the laser beam set to the recording power Pw is focused on the optical recording medium 1 via the light-transmitting layer 9.

When the laser beam is irradiated to the optical recording medium 1, the area of the light absorbing layer 5 where the laser beam is irradiated is heated. The heat generated in the light absorbing layer 5 is transmitted to the recording layer 7, and the temperature of the recording layer 7 increases.

Since platinum oxide contained in the recording layer 7 as a main component is high in transmitting property with respect to the laser beam, even when the laser beam is irradiated thereon, the recording layer 7 by itself can hardly generate heat, and hence it is difficult to increase the temperature of the recording layer 7 to a temperature higher than the decomposition temperature of the platinum oxide. However, in the present embodiment, since the light absorbing layer 5 is provided, the light absorbing layer 5 generates heat and the heat generated in the light absorbing layer 5 is transmitted to the recording layer 7, thereby increasing the temperature of the recording layer 7.

In this manner, the recording layer 7 is heated to a temperature higher than the decomposition temperature of platinum oxide, and the platinum oxide contained in the recording layer 7 as a main component is decomposed into platinum and oxygen.

Consequently, as shown in FIG. 3(b), the platinum oxide is decomposed and a void 7a is formed in the recording layer 7 by oxygen gas generated thereby, whereby fine particles 7b of platinum are separated out in the void 7a.

Simultaneously, as shown in FIG. 3(b), the recording layer 7 is deformed by a pressure of the oxygen gas together with the light absorbing layer 5 and the second dielectric layer 6.

In this manner, since the area where the void 7a is formed and the light absorbing layer 5, the second dielectric layer 6 and the recording layer 7 are deformed has different optical characteristics from other areas, the recording marks are formed by the area where the void 7a is formed and the light absorbing layer 5, the second dielectric layer 6, and the recording layer 7 are deformed.

I the area of the recording marks and the blank areas formed between the adjacent recording marks formed in this manner includes the one having a length shorter than λ/4NA, and the recording mark row smaller than the resolution limit is formed.

In the present embodiment, since the recording layer 7 contains platinum oxide which is high in decomposition temperature as a main component, even though heat is diffused in the peripheral portion of the recording layer 7 from the area where the laser beam is irradiated when irradiating the laser beam set to the recording power Pw to form the recording marks, the platinum oxide is prevented from generating a decomposition reaction in the area other than the area where the laser beam is irradiated, and hence the void 7a can be formed in the desired area of the recording layer 7 to form the recording marks.

In this manner, data is recorded in the optical recording medium 1, and the data recorded in the optical recording medium 1 is reproduced as follows.

When reproducing data from the optical recording medium 1, the laser beam set to the reproducing power Pr is focused on the optical recording medium 1 via the light-transmitting layer 9.

When the laser beam is irradiated on the optical recording medium 1, the laser beam is reflected from the optical recording medium 1, and the reflected laser beam is received by a light detector and converted into an electric signal, so that the data recorded in the optical recording medium 1 is reproduced.

In the present embodiment, the void 7a is formed in the recording layer 7, and fine particles 7b of platinum are separated out in the void 7a to form the recording marks and data is recorded therein. In this case, data can be reproduced even when the lengths of the recording marks constituting the recording mark row or the lengths of the blank areas between the adjacent recording marks are smaller than the resolution limit.

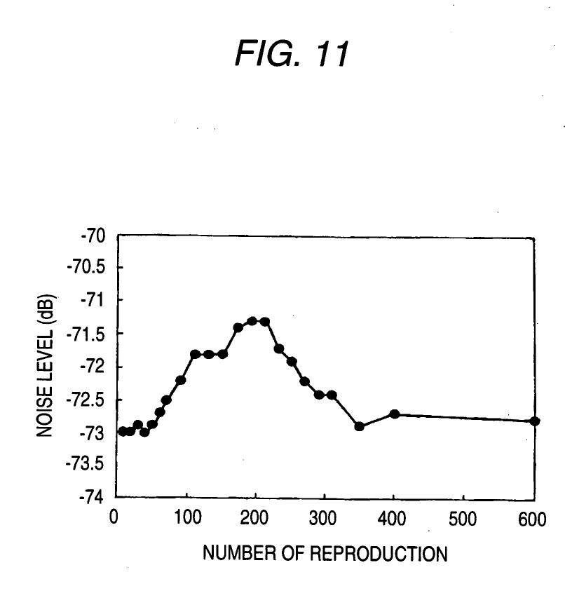

In the optical recording medium in the relate art, as shown in FIG. 11, there was a problem in that the noise level is increased when reproducing data recorded in the optical recording medium a plurality of numbers of times. However, according to the study of the Inventors, it is found that such a problem is caused by the fact that when a laser beam which has high reproducing power Pr is irradiated, the light absorbing layer 5 is heated and hence is subjected to a phase change, and since the speed of the phase change is not uniform in the plane of the light absorbing layer, there exist areas of amorphous material and areas of crystalline material irregularly on the light absorbing layer until the phase change has completed over the entire light absorbing layer, whereby the optical characteristics of the optical recording medium is adversely affected.

In the present embodiment, since the light absorbing layer 5 is crystalline material when film formation is completed, and has a property to maintain the crystalline material even when the laser beam is irradiated, even though the laser beam of high reproducing power Pr is irradiated and hence the light absorbing layer 5 is heated, the light absorbing layer 5 is not subjected to the phase change, and hence the reflection level with respect to the laser beam can always be stabilized irrespective of the number of times of reproducing, whereby the data recorded in the optical recording medium 1 can be reproduced stably a plurality of number of times.

In the present embodiment, the light absorbing layer 5 includes the mixture containing Sb as a main component, and is crystalline material. According to the study of the Inventors, it is found that when the light absorbing layer 5 is formed to include the mixture containing Sb as a main component and to be the crystalline material, even when the data recorded in the optical recording medium is reproduced a plurality of numbers of times, the reflection level with respect to the laser beam can be stabilized, and the recorded data can be reproduced with sufficiently high C/N ratio.

Therefore, according to the present embodiment, the data recorded by the recording mark row including at least one of the recording marks and the blank areas smaller than the resolution limit can be reproduced as desired a plurality of numbers of times.

In the present embodiment, the recording layer 7 contains the platinum oxide which is high in decomposition temperature as a main component, and hence even when the laser beam of high reproducing power Pr is irradiated to reproduce the data, the platinum oxide is prevented from being decomposed into platinum and oxygen, and hence even though the data recorded in the optical recording medium 1 is repeatedly reproduced, the shapes of the recording marks do not change, and formation of the additional void does not occur in the area other than the area where the recording marks are formed. Therefore, durability of the optical recording medium 1 against reproducing can be improved.

In the present embodiment, the supporting substrate 2 is formed with the reflecting layer 3, and when the laser beam set to the reproducing power Pr is irradiated thereon, heat provided by the laser beam can be diffused to the periphery from the position where the laser beam is irradiated by the reflecting layer 3. Therefore, excessive heating of the optical recording medium 1 can be reliably prevented, and the data recorded in the optical recording medium 1 can be prevented from deteriorating.

When the reflecting layer 3 is formed on the supporting substrate 2, the laser beam reflected from the surface of the reflecting layer 3 and the laser beam reflected from the layer laminated on the reflecting layer 3 interfere with each other, and consequently, the amount of light of the reflected light which constitutes the reproduced signal increases, whereby the C/N ratio of the reproduced signal can be improved of the present invention.

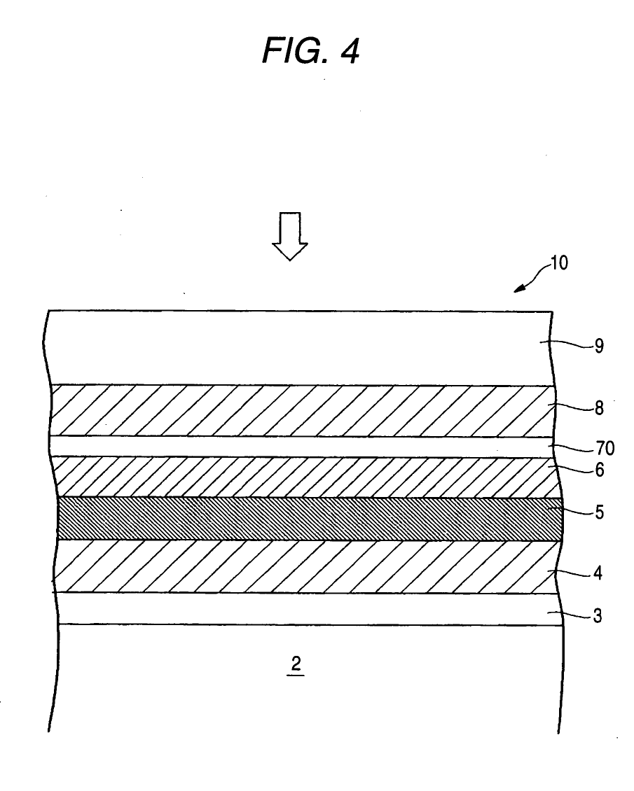

FIG. 4 is a schematic enlarged cross-sectional view of an optical recording medium according to another preferred embodiment.

As shown in FIG. 4, an optical recording medium 10 according to the present embodiment includes the supporting substrate 2, and the reflecting layer 3, the third dielectric layer 4, the light absorbing layer 5, the second dielectric layer 6, a recording layer 70, the first dielectric layer 8, the light-transmitting layer 9 are laminated on the supporting substrate 2 in this order.

In present embodiment as well, the laser beam is irradiated to record data in the optical recording medium 10, and the recorded data is reproduced.

The supporting substrate 2, the reflecting layer 3, the third dielectric layer 4, the light absorbing layer 5, the second dielectric layer 6, the first dielectric layer 8, and the light absorbing layer 9 of the optical recording medium 10 according to the present embodiment have the same functions as the supporting substrate 2, the reflecting layer 3, the third dielectric layer 4, the light absorbing layer 5, the second dielectric layer 6, the first dielectric layer 8, and the light absorbing layer 9 of the optical recording medium 1 shown in FIG. 2, and configured in the same manner.

In other words, in the present embodiment, the light absorbing layer 5 includes Sb and Sn or Sb and Bi as main components, and is crystalline material when film formation is completed, and has a property to maintain the crystalline material even when the layer beam is irradiated.

The recording layer 70 is a layer on which data is recorded, and when the data is recorded, the recording marks are formed on the recording layer 70.

In present embodiment, the recording layer 70 contains an organic dye as a main component. The organic dye contained in the recording layer 70 as a main component is preferably the one having absorbency with respect to the wavelength of the recording laser beam and a decomposition temperature of 300° C. or higher. For example, in the case of recording the data on the optical recording medium 10 by irradiating a laser beam having a wavelength from 390 to 420 nm, macrocyclic dyes such as phthalocyanine derivative, azaporphyrin derivative, porphycene derivative, corrole derivative or dyes such as coumarin derivative, metal-containing azaoxonol derivative, benzotriazole derivative, styryl derivative, hexatrien derivative can be used. Among these dyes, for example, mono-methine cyanine or porphyrin is preferable from the viewpoints of cost of the material itself, film-forming property, or absorbance with respect to the wavelength of the laser beam. The macrocyclic dyes such as porphyrin, in which pyrrole rings are connected, have a larger possibility to be improved in radiation proofing property by a central metal or by a modifying functional group.

The recording layer 70 may contain a mixture with a plurality of dyes mixed therein as a main component for optical adjustment, and element other than dye can be added for the purpose of achieving storage stability against high-temperature and high-humidity, radiation proofing property, promotion of decomposition, prevention of agglutination.

The thickness of the recording layer 70 is preferably from 1 nm to 50 nm. When the thickness of the recording layer 70 is smaller than 1 nm, the recording sensitivity is lowered, and there may be a case in which the recording layer 70 cannot be formed as a continuous film, and in contrast, when the thickness of the recording layer 70 exceeds 50 nm, when the recording laser beam is irradiated, heat tends to accumulate in the recording layer 70, and hence the influence of mutual thermal interference between the adjacent recording marks increases, and hence formation of the accurate recording marks may become difficult.

Data is recorded in the optical recording medium 10 configured as described above in the following manner.

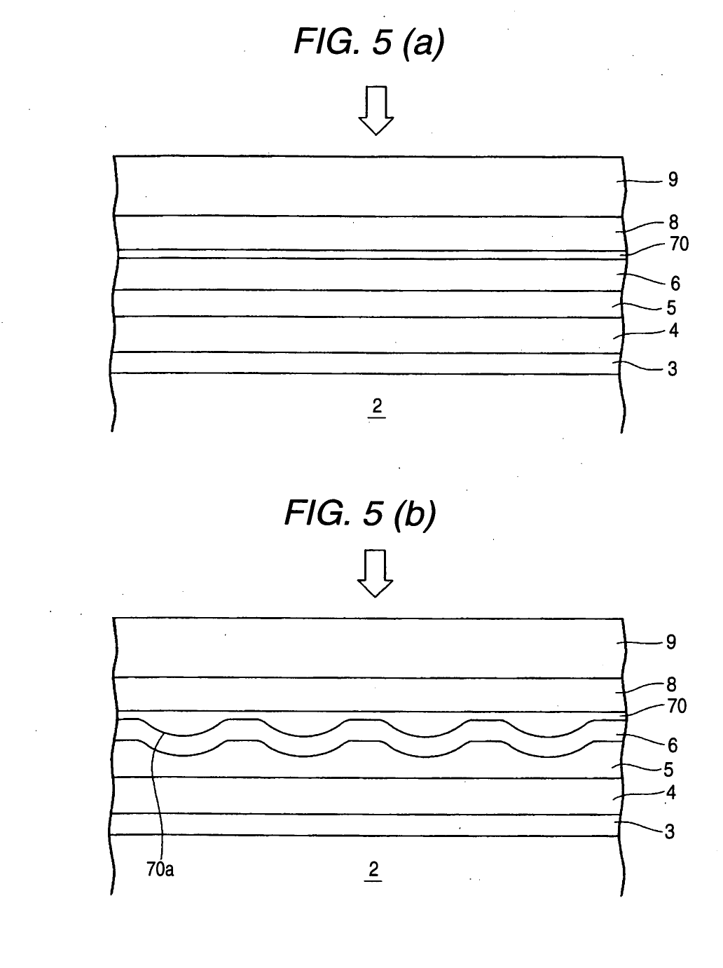

FIG. 5(a) is a partly enlarged schematic cross-sectional view of the optical recording medium 10 before data is recorded therein, and FIG. 5(b) is a partly enlarged schematic cross-sectional view of the optical recording medium 10 after data is recorded.

In present embodiment as well, since the data is recorded in high density, a laser beam having the wavelength λ from 390 nm to 420 nm is focused on the optical recording medium 10 by an objective lens having the numerical aperture from 0.7 to 0.9 NA.

When the laser beam set to the recording power is irradiated on the optical recording medium 10, the areas on the recording layer 70 and the light absorbing layer 5 where the laser beam is irradiated is heated. Consequently, the temperature of the recording layer 70 increased by heat generated in the recording layer 70 and heat generated in the light absorbing layer 5 and transmitted to the recording layer 70.

In this manner, the recording layer 70 is heated to a temperature higher than the fusing point of the organic dye or the decomposition temperature, and the organic dye contained in the recording layer 70 as a main component is fused, sublimated, or decomposed. Consequently, as shown in FIG. 5(b), the recording layer 70 is deformed in the area where the organic dye is fused, sublimated, or decomposed, and the deformed area 70a if formed in the recording layer 70. Simultaneously, as shown in FIG. 5(b), the second dielectric layer 6 and the light absorbing layer 5 are deformed with the recording layer 70, and the recording marks are formed.

The data is recorded in the optical recording medium 10, and the data recorded in the optical recording medium 10 is reproduced in the following manner.

When reproducing the data recorded in the optical recording medium 10, the laser beam set to the reproducing power Pr is focused on the optical recording medium 10 via the light-transmitting layer 9.

When the laser beam is irradiated on the optical recording medium 10, the laser beam is reflected from the optical recording medium 10, and the reflected laser beam is received by the light detector and converted into the electric signal, so that the data recorded in the optical recording medium 10 is reproduced.

In the present embodiment, the data is recorded by the organic dye contained in the recording layer 70 as a main component being fused, sublimated, or decomposed, thereby forming a deformed area 70a in the recording layer 70. In such a case, even when the lengths of the recording marks constituting the recording mark row or the lengths of the blank areas between the adjacent recording marks are smaller than the resolution limit, the data can be reproduced.

In the present embodiment, since the light absorbing layer 5 is crystalline material when film formation is completed, and has a property to maintain the crystalline material even when the laser beam is irradiated, even though the laser beam of high reproducing power Pr is irradiated and hence the light absorbing layer 5 is heated, the light absorbing layer 5 is not subjected to the phase change, and hence the reflection level with respect to the laser beam can always be stabilized irrespective of the number of times of reproducing, whereby the data recorded in the optical recording medium 10 can be reproduced stably a plurality of number of times.

In the present embodiment, since the light absorbing layer 5 includes the mixture containing Sb as a main component, and is crystalline material, even when the data recorded in the optical recording medium 10 is reproduced a plurality of numbers of times, the reflection level with respect to the laser beam can be stabilized, and the recorded data can be reproduced with sufficiently high C/N ratio.

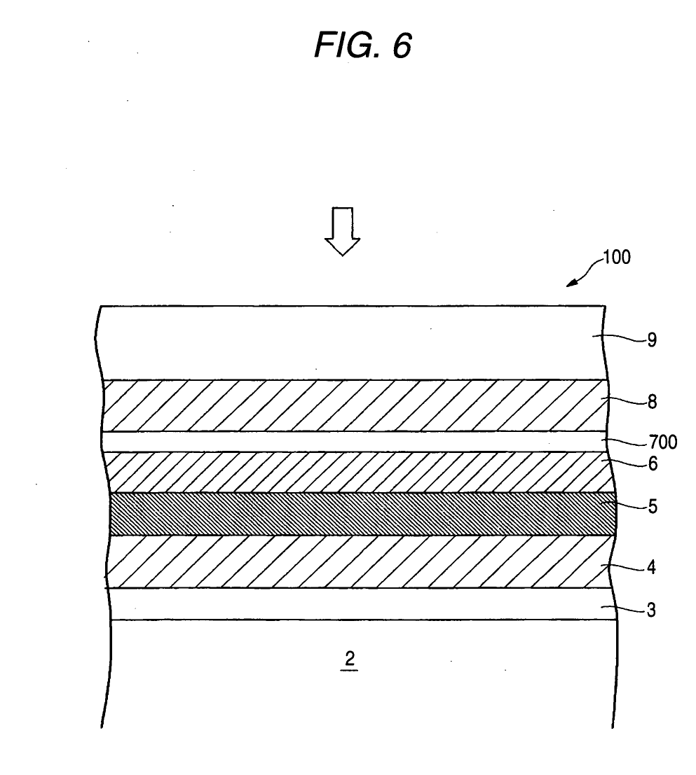

FIG. 6 is a schematic enlarged cross-sectional view of the optical recording medium according to another preferred embodiment of the present invention.

As shown in FIG. 6, an optical recording medium 100 according to the present embodiment includes the supporting substrate 2, and the reflecting layer 3, the third dielectric layer 4, the light absorbing layer 5, the second dielectric layer 6, a recording layer 700, the first dielectric layer 8, the light-transmitting layer 9 are laminated on the supporting substrate 2 in this order.

In present embodiment as well, the laser beam is irradiated via the light-transmitting layer 9 and to record data in the optical recording medium 100, and the recorded data is reproduced.

The supporting substrate 2, the reflecting layer 3, the third dielectric layer 4, the light absorbing layer 5, the second dielectric layer 6, the first dielectric layer 8, and the light absorbing layer 9 of the optical recording medium 100 according to the present embodiment have the same functions as the supporting substrate 2, the reflecting layer 3, the third dielectric layer 4, the light absorbing layer 5, the second dielectric layer 6, the first dielectric layer 8, and the light absorbing layer 9 of the optical recording medium 1 shown in FIG. 2, and configured in the same manner.

In other words, in the present embodiment as well, the light absorbing layer 5 includes Sb and Sn or Sb and Bi as main components, and is crystalline material when film formation is completed, and has a property to maintain the crystalline material even when the layer beam is irradiated.

The recording layer 700 is a layer on which data is recorded, and when the data is recorded, the recording marks are formed on the recording layer 700.

In the present embodiment, the recording layer 700 contains metal or semimetal having low coefficient of thermal conductivity as a main component. The metal or semimetal contained in the recording layer 700 as a main component is preferably the metal or semimetal having the coefficient of thermal conductivity of 2.0 W/(cm·K) or below, and more preferably, the recording layer 700 is formed of at least one kind of metal or semimetal selected from a group including Sn, Zn, Mg, Bi, Ti and Si or an allow including these metals or semimetals.

The recording layer 700 is preferably formed to have a thickness from 1 nm to 20 nm, and more preferably a thickness from 1 nm to 10 nm.

When the thickness of the recording layer 700 is smaller than 1 nm, the amount of deformation or the extent of alteration of the recording layer 700 when the recording laser beam is irradiated, and hence the reproducing sensitivity may be lowered. On the other hand, when the thickness of the recording layer 700 exceeds 20 nm, the coefficient of thermal conductivity of the recording layer 700 increases, and hence the recording sensitivity may be lowered, or the optical transmittance of the recording layer 700 may be lowered and hence incident of light into the light absorbing layer 5 may be impaired.

Data is recorded in the optical recording medium 100 configured as described above in the following manner.

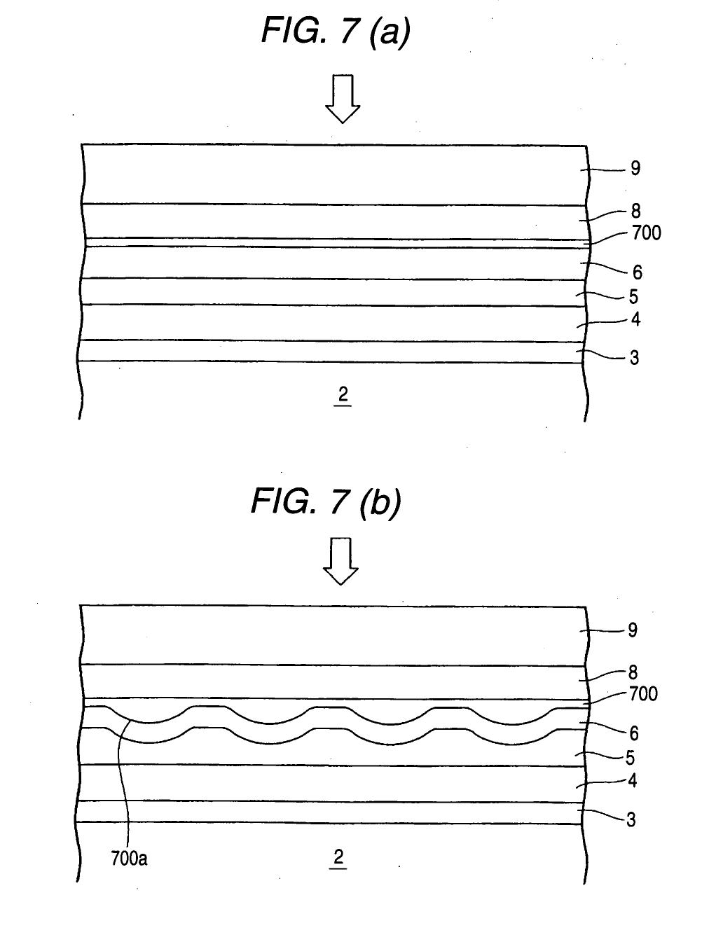

FIG. 7(a) is a partly enlarged schematic cross-sectional view of the optical recording medium 100 before data is recorded therein, and FIG. 7(b) is a partly enlarged schematic cross-sectional view of the optical recording medium 100 after data is recorded.

In the present embodiment as well, since the data is recorded in high density, a laser beam having the wavelength λ from 390 nm to 420 nm is focused on the optical recording medium 100 by an objective lens having the numerical aperture from 0.7 to 0.9 NA.

When the laser beam set to the recording power is irradiated on the optical recording medium 100, the areas on the recording layer 700 and the light absorbing layer 5 where the laser beam is irradiated is heated. Consequently, the temperature of the recording layer 700 increased by heat generated in the recording layer 700 and heat generated in the light absorbing layer 5 and transmitted to the recording layer 700.

When the temperature of the recording layer 700 is increased, the metal or semimetal contained in the recording layer 700 as a main component is deformed or altered. For example, when the metal or semimetal contained in the recording layer 700 as a main component is deformed, a deformed area 700a is formed in the recording layer 700 as shown in FIG. 7(b), and simultaneously, the second dielectric layer 6 and the light absorbing layer 5 are deformed together with the recording layer 700, whereby the recording marks are formed.

In the present embodiment, since the recording layer 700 contains the metal or semimetal having low coefficient of thermal conductivity as a main component, the area on the recording layer 700 where the laser beam set to the recording power is irradiated is efficiently heated, and hence the small recording marks smaller than the resolution limit can be formed efficiently.

Data is recorded in the optical recording medium 100 in this manner, and the data recorded in the optical recording medium 100 is reproduced in the following manner.

When reproducing data recorded in the optical recording medium 100, the laser beam set to the reproducing power Pr is focused on the optical recording medium 100 via the light-transmitting layer 9.

When the laser beam is irradiated on the optical recording medium 100, the laser beam is reflected form the optical recording medium 100, and the reflected laser beam is received by the light detector and converted into an electric signal, so that the data recorded in the optical recording medium 100 is reproduced.

In the present embodiment, the data is recorded by the metal or semimetal contained in the recording layer 700 as a main component being deformed or altered, and in this case, the lengths of the recording marks constituting the recording mark row or the length of the blank areas between the adjacent recording marks are smaller than the resolution limit, the data can be reproduced.

In the present embodiment, since the light absorbing layer 5 is crystalline material when film formation is completed, and has a property to maintain the crystalline material even when the laser beam is irradiated, even though the laser beam of high reproducing power Pr is irradiated and hence the light absorbing layer 5 is heated, the light absorbing layer 5 is not subjected to the phase change, and hence the reflection level with respect to the laser beam can always be stabilized irrespective of the number of times of reproducing, whereby the data recorded in the optical recording medium 100 can be reproduced stably a plurality of number of times.

In the present embodiment, sine the light absorbing layer 5 includes the mixture containing Sb as a main component, and is crystalline material, even when the data recorded in the optical recording medium 100 is reproduced a plurality of numbers of times, the reflection level with respect to the laser beam can be stabilized, and the recorded data can be reproduced with sufficiently high C/N ratio.

### EXAMPLES

In order to clarify the advantages of the present invention, examples will be shown below.

### Example 1

A polycarbonate substrate of 1.1 mm in thickness and 120 mm in diameter was set to a sputtering apparatus, and a reflecting layer of 20 nm in thickness is formed on the polycarbonate substrate by the sputtering method using a Pt target.

Subsequently, a third dielectric layer of 100 nm in thickness was formed by the sputtering method with a mixture of ZnS and SiO₂ as a target. The target mixture of ZnS and SiO₂ used here was a target in which the mol ratio between ZnS and SiO₂ was 80:20.

Subsequently, a light absorbing layer of 20 nm in thickness was formed on the surface of the third dielectric layer by the sputtering method with the Sb and Sn as the target. The composition of the light absorbing layer was Sb_{41.5}Sn_{58.5} in atomic ratio.

Subsequently, by using the target composed of the mixture of ZnS and SiO₂, a second dielectric layer of 60 nm in thickness was formed on the surface of the light-absorbing layer by the sputtering method. The target mixture of ZnS and SiO₂ used here was a target in which the mol ratio between ZnS and SiO₂ was 80:20.

Subsequently, using mixed gas containing Ar gas and oxygen gas as sputtering gas, a recording layer containing platinum oxide as a main component and of 4 nm in thickness was formed on the surface of the second dielectric layer using the Pt target by the sputtering method.

Subsequently, by using the target composed of the mixture of ZnS and SiO₂, a first dielectric layer of 50 nm in thickness is formed on the surface of the recording layer by the sputtering method. The target mixture of ZnS and SiO₂ used here was a target in which the mol ratio between ZnS and SiO₂ was 80:20.

Lastly, UV-curable acryl resin was applied on the surface of the first dielectric layer by the spin coat method to form a coated film, and UV ray was irradiated thereon for forming the light-transmitting layer of 100 μm. In this manner, a sample #1 was manufactured.

Subsequently, a sample #2 is manufactured in the following manner.

1. A reflecting layer of 20 nm in thickness and a third dielectric layer of 124 nm in thickness were formed in sequence on a polycarbonate substrate of 1.1 nm in thickness in the same manner as the sample #1.

Then, a light absorbing layer of 20 nm in thickness was formed on the surface of the third dielectric layer with Sn and Bi as targets by the sputtering method. The composition of the light absorbing layer was Sb_{52.0}Bi_{48.0} in atomic ratio.

Subsequently, a second dielectric layer of 75 nm in thickness, a recording layer of 4 nm in thickness, a first dielectric layer of 87 nm in thickness, and a light-transmitting layer of 100 μm in thickness were formed in sequence on the surface of the light absorbing layer as in the case of the sample #1. The sample #2 was manufactured in this manner.

Subsequently, a comparative sample #1 was manufactured in the following manner.

1. A reflecting layer of 20 nm in thickness and a third dielectric layer of 117 nm in thickness were formed in sequence on a polycarbonate substrate of 1.1 nm in thickness in the same manner as in the case of the sample #1.

Then, a light absorbing layer having a composition of Ag_{5.9}In4.4Sb_{61.1}Te_{28.6} in atomic ratio and of 20 nm in thickness was formed on the surface of the third dielectric layer by the sputtering method.

Subsequently, a second dielectric layer of 71 nm in thickness, a recording layer having 4 nm in thickness, a first dielectric layer of 87 nm in thickness, and a light-transmitting layer of 100 μm in thickness were formed in sequence on the surface of the light absorbing layer in the same manner as the sample #1. The comparative sample #1 was manufactured in this manner.

Subsequently, samples from the sample #1 to the comparative sample #1 wee set in sequence in an optical recording medium verification device, “DDU1000” (product name) of Pulstec Industrial Co., Ltd., a laser beam was focused via the light-transmitting layer using a blue laser beam of 405 nm in wavelength as a recording laser beam, and an objective lens of 0.85 NA in numerical aperture. Then, under the following conditions, a recording mark row including recording marks of 75 nm and blank areas of 75 nm was formed on the recording layer of the sample #1 and data was recorded. For recording data on the samples from the sample #1 to the comparative sample #1, the recording power Pw of the laser beam was set to 6.5 mW, 9.0 mW, and 10.0 mW, respectively.

Recording linear velocity: 4.9 m/s

Recording system: On group recording

Subsequently, the samples from the sample #1 to the comparative sample #1 were set in sequence to the above-described optical recording medium verification device, data recorded on the samples from the sample #1 to the comparative sample #1 respectively were reproduced on the same track three-hundred times, and the C/N ratio of the reproduced signals were measured. For reproducing the data recorded in the samples form the sample #1 to the comparative sample #1, the reproducing power Pr of the laser beam was set to 2.8 mW, 1.6 mW, and 2.0 mW, respectively, and the reproducing linear velocity was set to 4.9 m/s for all the samples.

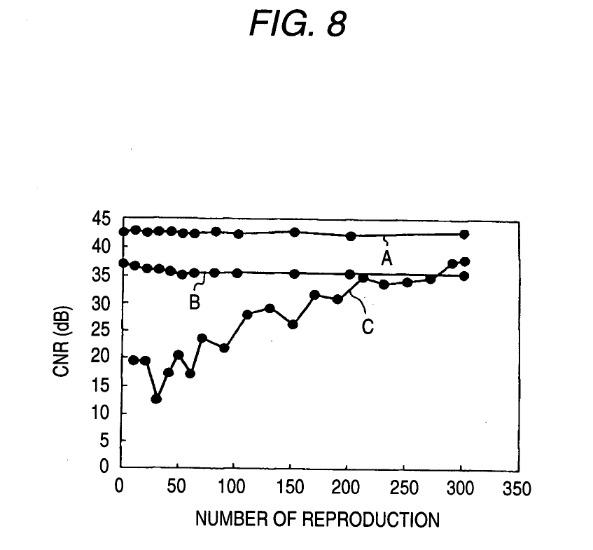

The results of measurement were represented by curved lines A to C in FIG. 8.

As is clear from FIG. 8, in the comparative sample #1, the C/N ratio of the reproduced signal was significantly fluctuated until the number of times of reproducing reaches about 200 times, and hence the recorded data could not be reproduced stably. In contrast, in the samples #1 and #2, almost no variation was found in the C/N ratio of the reproduced signals every time from the first reproducing to the 300th reproducing. Accordingly, it was found that the recorded data could be reproduced stably irrespective of the number of times of reproducing.

### Example 2

A light absorbing layer having the same composition as the light absorbing layer of the sample #1 and of 250 nm in thickness was formed on the surface of a polycarbonate substrate of 1.2 mm in thickness to form a sample #1-1.

Then, a light absorbing layer having the same composition as the light absorbing layer of the sample #2 and of 250 nm in thickness was formed on the surface of a polycarbonate substrate of 1.2 mm in thickness to form a sample #2-1.

Subsequently, using the X-ray diffracting device “ATX-G” (name of product) from Rigaku Corporation, the crystalline states of the light absorbing layers of the sample #1-1 and the sample #2-1 were analyzed. For analyzing the crystalline states of the light absorbing layers, Cu was used as a target, and the tube pressure was set to 50 kV, and the tube current was set to 300 mA.

As a result of analysis, it was found that the light absorbing layers are entirely crystalline material in the samples #1-1 and #2-1.

Subsequently, samples #1-2 and #2-2 having the same structure as the samples #1 and #2 are manufactured respectively.

Subsequently, the samples #1-2 and #2-2 are set in sequence in the aforementioned optical recording medium verification device and the laser beams set to the power of 6.5 mW and 9.0 mW were irradiated respectively.

Subsequently, using a transmission electron microscope “JEM-3010” (product name) from JAPAN ELECTRON OPTICS LABORATORY CO., LTD, the crystalline states of the areas of the light absorbing layers of the samples #1-2 and #2-2 where the laser beam was irradiated were analyzed. As a result of analysis, it was found the both of the samples #1-2 and #2-2 were crystalline material and no amorphous area was formed on the light absorbing layers.

### Example 3

Except for the point that the composition of the light absorbing layer was set to Sb_{90.8}Sn_{9.2} in atomic ratio, a sample #3 was manufactured in the same manner as the sample #1.

Subsequently, except for the point that the composition of the light absorbing layer was changed as shown in Table 1, samples #4 and #11, and comparative samples #2 and #3 are manufactured in the same manner as the sample #3.

TABLE 1

Content (atomic %)

| | Sb | Sn |
|---|---|---|
| Sample #4 | 79.5 | 20.5 |
| Sample #5 | 75.7 | 24.3 |
| Sample #6 | 64.3 | 35.7 |
| Sample #7 | 52.9 | 47.1 |
| Sample #8 | 41.5 | 58.5 |
| Sample #9 | 30.2 | 69.8 |
| Sample #10 | 15.0 | 85.0 |
| Sample #11 | 11.1 | 88.9 |
| Comparative Sample #2 | 100 | 0 |
| Comparative Sample #3 | 0 | 100 |

Subsequently, the sample #3 and the comparative sample #3 are set in sequence in the above-described optical recording medium verification device, recording mark rows including recording marks of 75 nm and blank areas of 75 nm were formed on the recording layers of the sample #3 and the comparative sample #3, and data were recorded. For recording data on the recording layers of the sample #3 and the comparative sample #3, the recording power Pw of the laser beam was set respectively to 10.0 mW, 8.0 mW, 6.5 mW, 6.5 mW, 7.0 mW, 7.0 mW, 7.0 mW, 7.0 mW, 8.0 mW, 11.0 mW, and 9.0 mW

After the data was recorded, the data recorded on the sample #3 was reproduced by using the same optical recording medium verification device, and the C/N ratio fo the reproduced signal was measured. For reproducing the data, the reproducing power Pr of the laser beam was set to 1.8 mW.

Subsequently, the reproducing power Pr of the laser beam was increased gradually within the range from 1.8 mW to 4.0 mW, and the data recorded on the recording layer of the sample #1 was reproduced in sequence.

Then, in the same manner as the sample #3, the data recorded on the sample #4 and the comparative sample #3 were reproduced, and the C/N ratios of the reproduced signal were measured. For reproducing the data recorded on the recording layers of the samples from the sample #4 to the comparative sample #3, the reproducing power Pr of the laser beam was changed respectively in the range from 2.8 mW to 3.6 mW, the range form 2.2 mW to 3.2 mW, the range from 2.4 mW to 3.4 mW, the range from 2.4 mW to 3.4 mW, the range from 2.2 mW to the range 3.2 mW, the range from 2.2 mW to 3.0 mW, the range from 2.8 mW to 3.6 mW, the range from 2.0 mW to 2.8 mW, the range from 2.0 mW to 3.2 mW, the range from 0.8 mW to 1.8 mW.

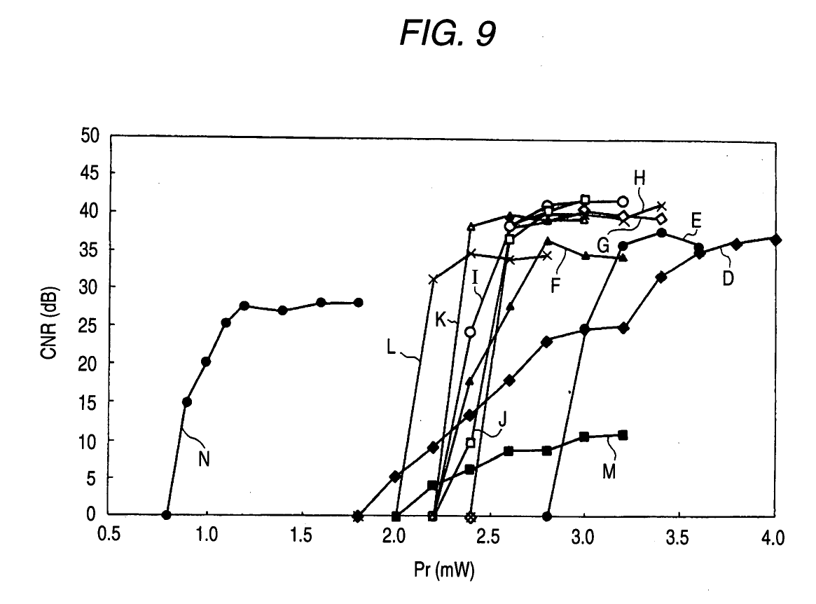

Graphs showing relations between the C/N ratios of the reproduced signals in the sample #3 and the comparative sample #3 and the reproducing power Pr of the laser beam are represented by curved lines D to N in FIG. 9.

As represented by curved lines D to L in FIG. 9, the highest C/N ratios in the samples from the samples #3 to #11 were respectively 37.3 dB, 38.1 dB, 37.0 dB, 40.7 dB, 41.4 dB, 42.0 dB, 42.2 dB, 40.0 dB, and 35.0 dB, and the reproduced signals with sufficiently high C/N ratios are obtained. In particular, as shown by curved lines G to K in FIG. 9, the reproduced signals with the sufficiently higher C/N ratios were obtained in every sample from the samples #6 to #10. In contrast, as indicated by the cured lines M and N in FIG. 9, the highest C/N ratios of the comparative samples #2 and #3, the highest C/N ratios were 11.2 dB and 5.0 dB respectively, and the reproduced signals with the high C/N ratio could not be obtained.

### Example 4

Except for the point that the composition of the light absorbing layer was Sb₇₅Bi₂₅ in atomic ratio, a sample #12 was manufactured in the same manner as the sample #2.

Subsequently, except for the point that the composition of the light absorbing layer was changed as shown in FIG. 2, samples from samples #13 to #15 and a comparative sample #4 were manufactured in the same manner as the sample #12.

TABLE 2

Content (atomic %)

| | Sb | Bi |
|---|---|---|
| Sample #13 | 59 | 41 |
| Sample #14 | 52 | 48 |
| Sample #15 | 35 | 65 |
| Comparative Sample #4 | 0 | 100 |

Subsequently, the samples from the samples S12 to the comparative sample #4 were set to the same optical recording medium verification device, the laser beam was focused, a recording mark row including recording marks of 75 nm and blank areas of 75 nm was formed, and data was recorded.

For recording data, the recording power Pw of the laser beam was set to 9.0 mW, 10.0 mW, 9.0 mW, 9.0 mW, and 7.0 mW, respectively.

After the data was recorded, the data recorded in the samples form the sample #12 to the comparative sample #4 were reproduced by using the same optical recording medium verification device, and the C/N ratios of the reproduced signals were measured. For reproducing the data, the reproducing power Pr of the laser beam was changed respectively in the range from 1.0 mW to 2.2 mW, the range from 1.0 mW to 2.4 mW, the range from 1.0 mW to 2.2 mW, the range from 0.8 mW to 2.0 mW, the range from 0.5 mW to 1.6 mW.

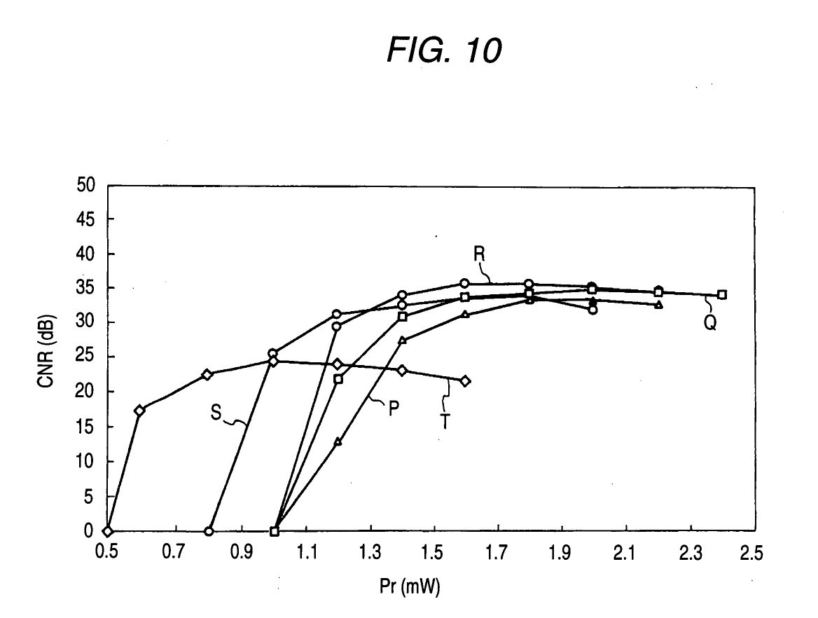

A graph showing relations between the C/N ratios of the reproduced signals of the samples from the sample #12 to the comparative sample #4 and the reproducing power Pr of the laser beam are represented by curved lines P to T in FIG. 10.

As represented by curved lines P to S in FIG. 10, the highest C/N ratios in the samples from the sample #12 to #15 were 33.8 dB, 35.8 dB, 35.9 dB, and 33.7 dB respectively, and the reproduced signals of the sufficiently high C/N ratios higher than 30 dB could be obtained. In contrast, as shown by the curved line T in FIG. 10, the highest C/N ratio in the comparative sample #4 was 24.9 dB, and the reproduced signal with the high C/N ratio could not be obtained.

The present invention is not limited to the above-described embodiments and examples, and various modifications can be made within the scopes of the invention as set force in Claims, and those are also included in the scope of the present invention as a mater of course.

For example the optical recording mediums 1, 10, 100 according to the embodiments shown in FIG. 1, FIG. 2, FIG. 4 and FIG. 6 are constructed in such a manner that the supporting substrate 2 and the reflecting layer 3, the third dielectric layer 4, the light absorbing layer 5, the second dielectric layer 6, the recording layers 7, 70, 700, the first dielectric layer 8 and the light-transmitting layer 9 are laminated in this order on the supporting substrate 2, and the laser beam is irradiated from the side of the light-transmitting layer 9. However, the present invention is not limited thereto and, for example, it can also be applied to an optical recording medium of DVD type, in which a light transmitting substrate that transmits the laser beam is provided, the first dielectric layer 8, the recording layers 7, 70, 700, the second dielectric layer 6, the light absorbing layer 5 and the third dielectric layer 4 are laminated in sequence on the light-transmitting substrate, and the laser beam is irradiated from the side of the light transmitting substrate.

Also, in the optical recording mediums 1, 10, 100 according to the embodiments shown in FIG. 1, FIG. 2, FIG. 4 and FIG. 6, the recording layer 7, the second dielectric layer 6 and the light absorbing layer 5 are laminated in sequence from the light incident surface for the laser beam. However, the present invention is not limited thereto and, for example, the recording layers 7, 70, 700, the second dielectric layer 6, and the light absorbing layer 5 are laminated in sequence from the opposite side from the light incident surface for the laser beam, or the light absorbing layer, the dielectric layer, the recording layer, the dielectric layer, and the light absorbing laser may be laminated in sequence from the light incident surface for the laser beam. In other words, in the present invention, the optical recording medium must simply be provided with the laminated body including the recording layer and the light absorbing layer at least with the intermediary of the dielectric layer.

1. An optical recording medium on which a recording mark row containing at least one of recording marks and blank areas smaller than a resolution limit is formed to record data and from which the recorded data are reproduced, by irradiating a laser beam, said optical recording medium comprising:
a layered body including a recording layer, a light absorbing layer, and a dielectric layer at intermediary of the recording layer and the light absorbing layer,
wherein the light absorbing layer is crystalline when film formation is completed, and has a property to maintain the crystalline even when the laser beam is irradiated.

2. The optical recording medium according to claim 1, wherein the light absorbing layer comprises a mixture containing Sb as a main component, and is crystalline material.

3. The optical recording medium according to claim 1, wherein the light absorbing layer contains Sb and Sn, or Sb and Bi as main components.

4. The optical recording medium according to claim 3, wherein the light absorbing layer contains Sb and Sn as main components, the light absorbing layer contains preferably 9 atom percent to 90 atomic % of Sn.

5. The optical recording medium according to claim 3, characterized in that the light absorbing layer contains Sb and Bi as main components, the light absorbing layer contains preferably 25 atomic % to 65 atomic % of Bi.

6. The optical recording medium according to claim 1, wherein the recording layer comprises noble metal oxide as a main component, and is decomposed into noble metal and oxygen when a laser beam set to a recording power is irradiated.

7. The optical recording medium according to claim 6, wherein the noble metal oxide is composed of platinum oxide, and is decomposed into platinum and oxygen when the laser beam set to the recording power is irradiated.

8. The optical recording medium according to claim 1, wherein a reflecting layer is formed on the substrate.

9. The optical recording medium according to claim 1, wherein the dielectric layer and the light absorbing layer are configured to be deformed in accordance with volume change of the recording layer when the recording mark row is formed on the recording layer.

10. The optical recording medium according to claim 9, wherein the dielectric layer contains a mixture of ZnS and SiO₂ as a main component.
